(19) United States
(12) Patent Application Publication
(10) Pub. No.: US 2015/0024721 A1
(43) Pub. Date: Jan. 22, 2015

(54) AUTOMATICALLY CONNECTING/DISCONNECTING AN INCOMING PHONE CALL TO A DATA PROCESSING DEVICE BASED ON DETERMINING INTENT OF A USER THEREOF TO RESPOND TO THE INCOMING PHONE CALL

(71) Applicant: NVIDIA Corporation, Santa Clara, CA (US)

(72) Inventor: Bibek Basu, Bangalore (IN)

(21) Appl. No.: 13/948,139

(22) Filed: Jul. 22, 2013

(51) Int. Cl. H04M 1/725

(52) U.S. Cl. CPC H04M 1/72522
USPC 455/414.1

(57) ABSTRACT

A method includes triggering determination of an intent of a user of a data processing device to respond to an incoming phone call thereto through a processor of the data processing device in conjunction with one or more sensor(s) associated therewith based on initiation through the incoming phone call or the user. The method also includes automatically connecting to or disconnecting the incoming phone call through the processor following the determination of the intent of the user to respond to the incoming phone call without requiring the user to intervene on the data processing device therefor.

### FIELD OF TECHNOLOGY

This disclosure relates generally to data processing devices and, more particularly, to automatically connecting/disconnecting an incoming phone call to a data processing device based on determining intent of a user thereof to respond to the incoming phone call.

### BACKGROUND

A data processing device such as a mobile phone or a tablet may have a locked setting associated with an incoming phone call thereto. In accordance therewith, a user of the data processing device may have to swipe a portion of a touchscreen thereof, press a physical button thereof or press a key of a keypad thereof to connect to/disconnect the incoming phone call. The user may hold the data processing device with one hand thereof and perform the aforementioned action(s) with the other hand. During scenarios where the use of the hands of the user is limited, the aforementioned operations may frustrate the user.

### SUMMARY

Disclosed are a method, a device and/or a system of automatically connecting/disconnecting an incoming phone call to a data processing device based on determining intent of a user thereof to respond to the incoming phone call.

In one aspect, a method includes triggering determination of an intent of a user of a data processing device to respond to an incoming phone call thereto through a processor of the data processing device in conjunction with one or more sensor(s) associated therewith based on initiation through the incoming phone call or the user. The method also includes automatically connecting to or disconnecting the incoming phone call through the processor following the determination of the intent of the user to respond to the incoming phone call without requiring the user to intervene on the data processing device therefor.

In another aspect, a non-transitory medium, readable through a data processing device and including instructions embodied therein that are executable through the data processing device, is disclosed. The non-transitory medium includes instructions to trigger determination of an intent of a user of a data processing device to respond to an incoming phone call thereto through a processor of the data processing device in conjunction with one or more sensor(s) associated therewith based on initiation through the incoming phone call or the user. The non-transitory medium also includes instructions to automatically connect to or disconnect the incoming phone call through the processor following the determination of the intent of the user to respond to the incoming phone call without requiring the user to intervene on the data processing device therefor.

In yet another aspect, a data processing device includes a memory, one or more sensor(s) and a processor communicatively coupled to the memory and the one or more sensor(s). An incoming phone call to the data processing device or a user of the data processing device is configured to trigger determination of an intent of the user to respond to the incoming phone call through the processor in conjunction with the one or more sensor(s). Based on the determination, the processor is configured to execute instructions to automatically connect to or disconnect the incoming phone call without requiring the user to intervene on the data processing device therefor.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is an illustrative view of a requirement of intervention on part of a user of the data processing device of FIG. 1 to connect to an incoming phone call either by swiping a portion of a touchscreen or by depressing a key of a keyboard/keypad.

FIG. 3 is a schematic view of an example triggering of sensing through one or more sensor(s) of the data processing device of FIG. 1 in conjunction with a processor thereof, based on which the user of the data processing device is automatically connected to the incoming phone call without a requirement of intervention thereof.

FIG. 4 is a schematic view of interaction between a driver component and the processor, the one or more sensor(s) and/or a display unit of the data processing device of FIG. 1, according to one or more embodiments.

FIG. 5 is a schematic view of a memory of the data processing device of FIG. 1 including a character map and a touch gesture map, according to one or more embodiments.

FIG. 6 is an illustrative view of an example coordinate system in which the data processing device of FIG. 1 is placed.

FIG. 7 is an illustrative view of an example movement of the data processing device of FIG. 1 toward an ear of the user thereof.

FIG. 8 is a schematic view of an example proximity sensor of the data processing device of FIG. 1.

FIG. 9 is a process flow diagram detailing the operations involved in automatic connection/disconnection of the incoming phone call to the data processing device of FIG. 1 based on determining intent of the user thereof to respond to the incoming phone call, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of automatically connecting/disconnecting an incoming phone call to a data processing device based on determining intent of a user thereof to respond to the incoming phone call. Although the present embodiments have been described with reference to specific example embodiments, it will be evident that various modifications and changes may be made to these embodiments without departing from the broader spirit and scope of the various embodiments.

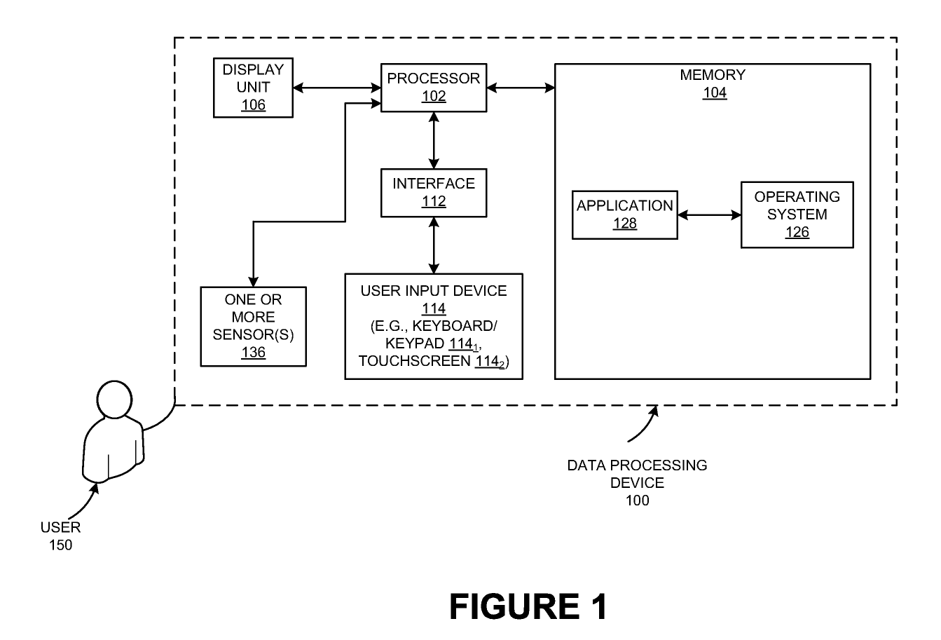

FIG. 1 shows a data processing device 100, according to one or more embodiments. In one or more embodiments, data processing device 100 may be a portable mobile device such as a mobile phone or a tablet. Other forms of data processing device 100 are within the scope of the exemplary embodiments discussed herein. In one or more embodiments, data processing device 100 may include a processor 102 (e.g., a Central Processing Unit (CPU), a Graphics Processing Unit (GPU)) communicatively coupled to a memory 104 (e.g., a volatile memory and/or a non-volatile memory); memory 104 may include storage locations addressable through processor 102.

In one or more embodiments, data processing device 100 may include a display unit 106 (e.g., a Liquid Crystal Display (LCD), a Light Emitting Diode (LED) display) configured to have display data rendered thereon; FIG. 1 shows processor 102 as being interfaced with display unit 106. For example, processor 102 may process display data and perform conversion thereof into a format compatible with display unit 106. In one or more embodiments, data processing device 100 may also include an interface 112 (e.g., a port) interfaced with processor 102 through which a user input device 114 may be coupled to processor 102. In one or more embodiments, user input device 114 may be a keyboard/keypad, a pointing device (e.g., a trackball, touchpad) or a touchscreen. FIG. 1 shows a keyboard/keypad 114₁ and a touchscreen 114₂ as example user input device(s) 114.

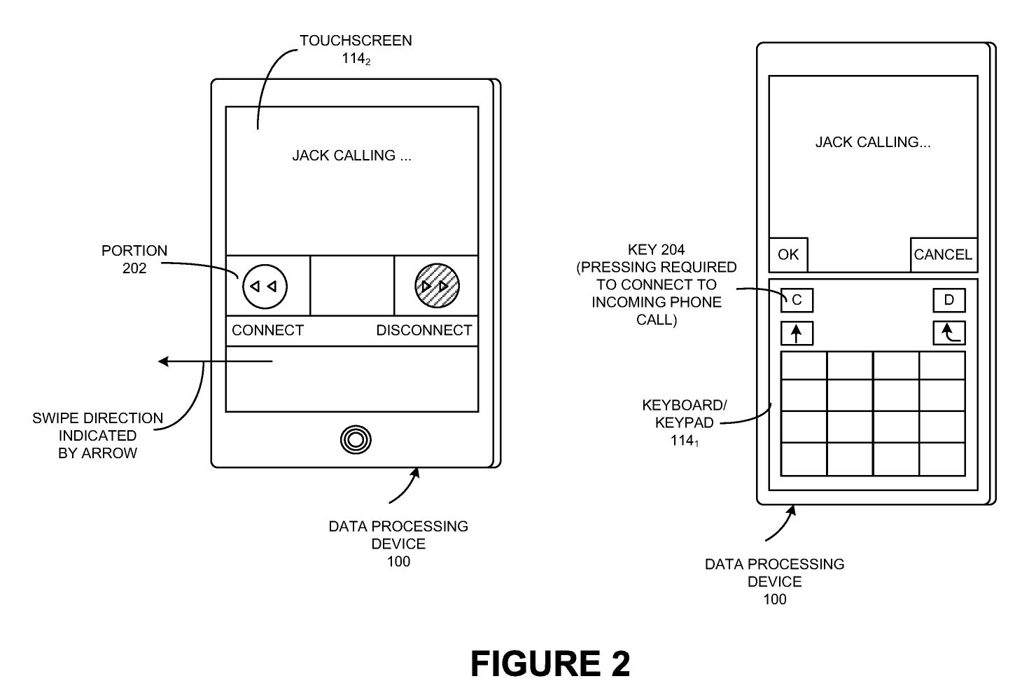

When data processing device 100 (e.g., a mobile phone) receives a phone call, a user 150 thereof may have to perform a gesture on touchscreen 114₂ provided as a feature of display unit 106 or depress a key of keyboard/keypad 114₁ to connect to the phone call. In an alternate implementation, user 150 may have to press a physical button on data processing device 100 therefor. FIG. 2 shows the requirement of intervention on part of user 150 either by swiping a portion 202 of touchscreen 114₂ or by depressing a key 204 of keyboard/keypad 114₁. The aforementioned requirement of physical intervention on part of user 150 may inconvenience user 150 especially during occasions such as travel in a car where user 150 is driving the car. In another example scenario, user 150 may be holding a suitcase in one hand while receiving a phone call through data processing device 100. The requirement of effectively utilizing one hand to connect to the phone call may prove to be frustrating to user 150.

In one or more embodiments, data processing device 100 may include one or more sensor(s) 136 interfaced with processor 102 (e.g., through interface 112, another interface) configured to sense an intent of user 150 to respond to the phone call. The one or more sensor(s) 136 may, for example, be a touch sensor configured to sense a touch of user 150 or a motion sensor (e.g., a position sensor, an accelerometer, a magnetometer, a gyroscope) configured to detect motion of data processing device 100 indicative of user 150 being a cause thereof. When user 150 receives the phone call through data processing device 100, user 150 may physically pick up data processing device 100 and, in the process, touch the one or more sensor(s) 136 and subject data processing device 100 to motion. If the one or more sensor(s) 136 includes a touch sensor, the touch of user 150 may be sensed; if the one or more sensor(s) 136 includes a motion sensor, the motion of data processing device 100 may be sensed. Both example forms of sensing may indicate intent of user 150 to respond to the phone call.

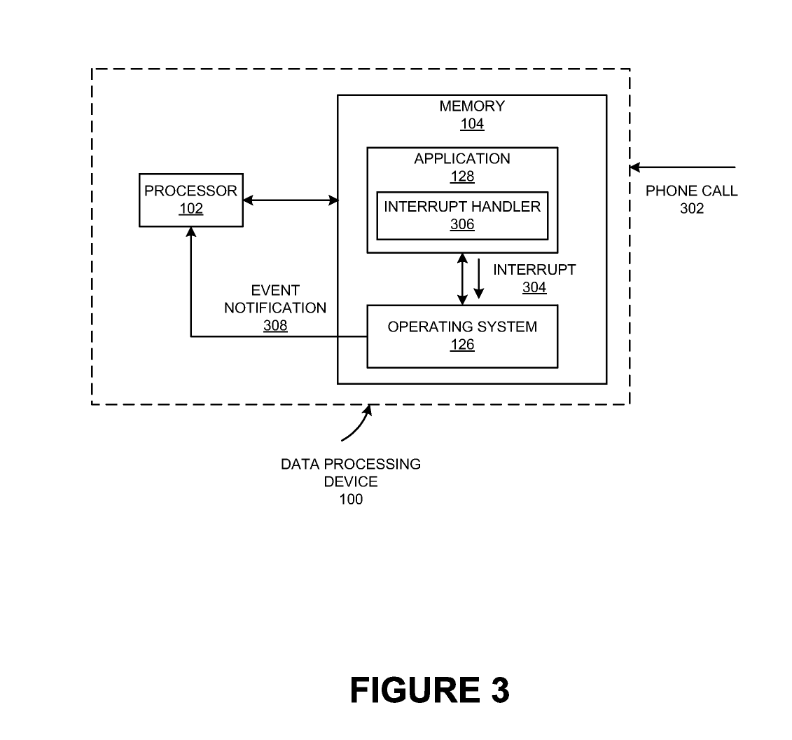

In one or more embodiments, the one or more sensor(s) 136 may also sense the intent of user 150 to respond to the phone call based on determining proximity of data processing device 100 to an ear of user 150. In order to dispense with false positives, the incoming phone call may trigger the sensing through the one or more sensor(s) 136 in conjunction with processor 102. FIG. 3 illustrates an example triggering of the sensing through the one or more sensor(s) 136 in conjunction with processor 102, based on which user 150 is automatically connected to the phone call through data processing device 100 without a requirement of intervention thereof.

When data processing device 100 receives an incoming phone call 302, a process (e.g., an application 128 shown as being stored in memory 104 in FIG. 1) executing on data processing device 100 may be configured to generate an interrupt 304 to an operating system 126 (also shown as being stored in memory 104 in FIG. 1) executing on data processing device 100. In one or more embodiments, application 128 interfaced with operating system 126 or operating system 126 may include an interrupt handler 306 to handle said interrupt 304. FIG. 3 shows interrupt handler 306 as being implemented in application 128. Operating system 126 may then generate an event notification 308 that is detected through processor 102. Other forms of detection of phone call 302 are within the scope of the exemplary embodiments. Once phone call 302 is detected through processor 102 based on event notification 308, application 128, operating system 126 and/or processor 102 may trigger initiation of the sensing discussed above through a driver component (e.g., a set of instructions) associated with processor 102, the one or more sensor(s) 136 or display unit 106.

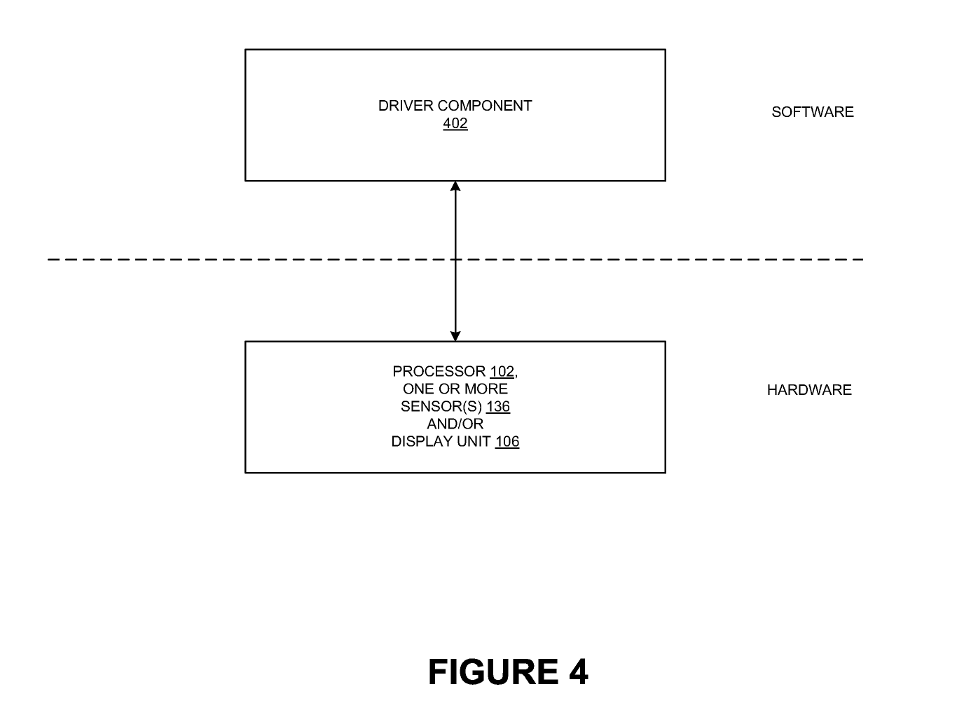

FIG. 4 shows interaction between a driver component 402 and processor 102, the one or more sensor(s) 136 and/or display unit 106, according to one or more embodiments. In one or more embodiments, driver component 402 may initiate the sensing of the intent of user 150 to respond to phone call 302 and the subsequent automatic connection to phone call 302 through data processing device 100 without a requirement of user 150 to intervene on data processing device 100 therefor, as will be discussed below. In one or more embodiments, instructions associated with driver component 402, the sensing and/or the automatic connection may be packaged with application 128 and/or operating system 126. In one or more embodiments, the aforementioned instructions may also be available on a non-transitory medium (e.g., a Compact Disc (CD), a Digital Video Disc (DVD), a Blu-ray disc®, a removable mass storage medium such as a Universal Serial Bus (USB) drive, a hard drive; appropriate instructions may be downloaded to the hard drive) readable through data processing device 100.

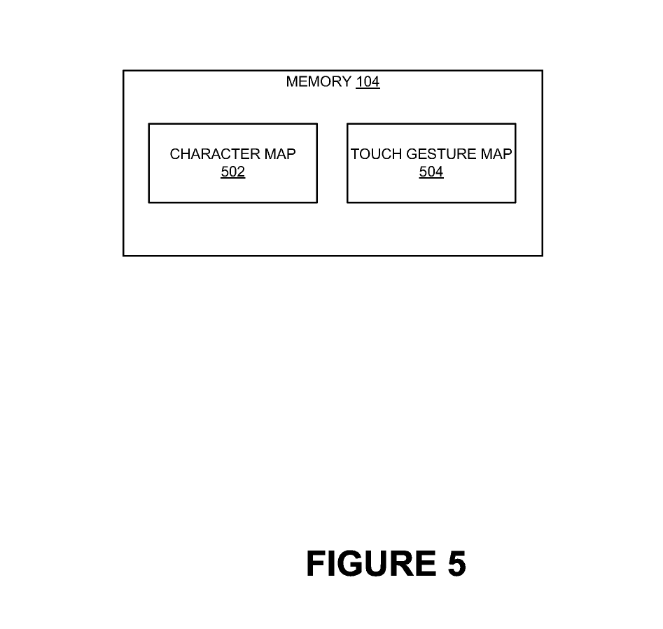

The data sensed through the one or more sensor(s) 136 may be transmitted to processor 102 for determining the intent of user 150 to respond to phone call 302. In one or more embodiments, as shown in FIG. 5, memory 104 (e.g., a non-volatile memory such as a Read-Only Memory (ROM)) may include a character map 502 and/or a touch gesture map 504; character map 502 may include a correspondence between each key of keyboard/keypad 114₁ and one or more functionalities associated therewith; touch gesture map 504 may include a correspondence between a touch gesture performable on touchscreen 114₂ and one or more functionalities associated therewith. Upon sensing the intent of user 150 to respond to phone call 302, processor 102 may contextually select a functionality associated with connecting to phone call 302 using an appropriate key or a touch gesture on data processing device 100. Thus, processor 102 may enable data processing device 100 mimic depressing a key of keyboard/keypad 114₁ on part of user 150 or swiping an appropriate portion of touchscreen 114₂ on part of user 150 without actually requiring user 150 to perform the aforementioned action(s). Other forms of automatic connection to phone call 302 are within the scope of the exemplary embodiments discussed herein.

In one or more embodiments, the one or more sensor(s) 136 may utilize an accelerometer, a gyroscope, a magnetometer and/or a proximity sensor. In an example scenario, user 150 may pick up data processing device 100 from a rest position toward his/her ear. In one example embodiment, the one or more sensor(s) 136 in conjunction with processor 102 may utilize a standard three-axis coordinate system to sense data, values of which are referenced based on: the x-axis being on a horizontal plane, the y-axis being on a vertical plane, and the z-axis being on a plane that is perpendicular to that of both the x-axis and the y-axis. The coordinate system may be defined relative to display unit 106, specifically when data processing device 100 is held in a default orientation. For example, the default orientation of data processing device 100 may be defined as a position in which display unit 106 is parallel to the y-axis. Here, the movement of data processing device 100 toward the ear of user 150 may be sensed as the intent of user 150 to respond to phone call 302.

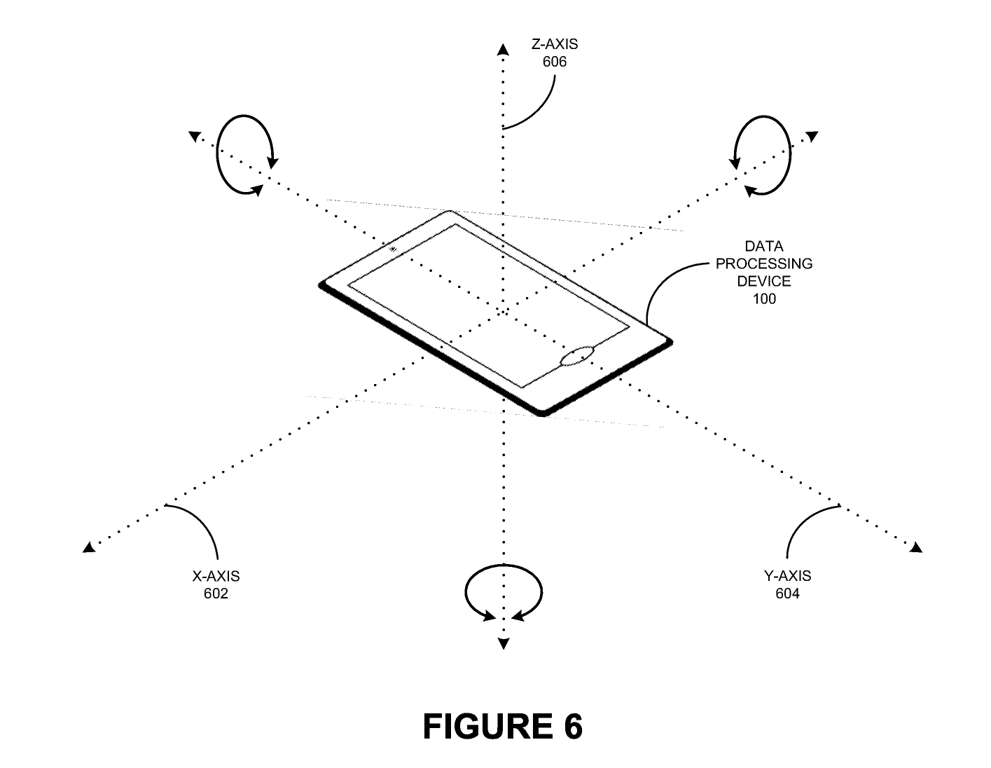

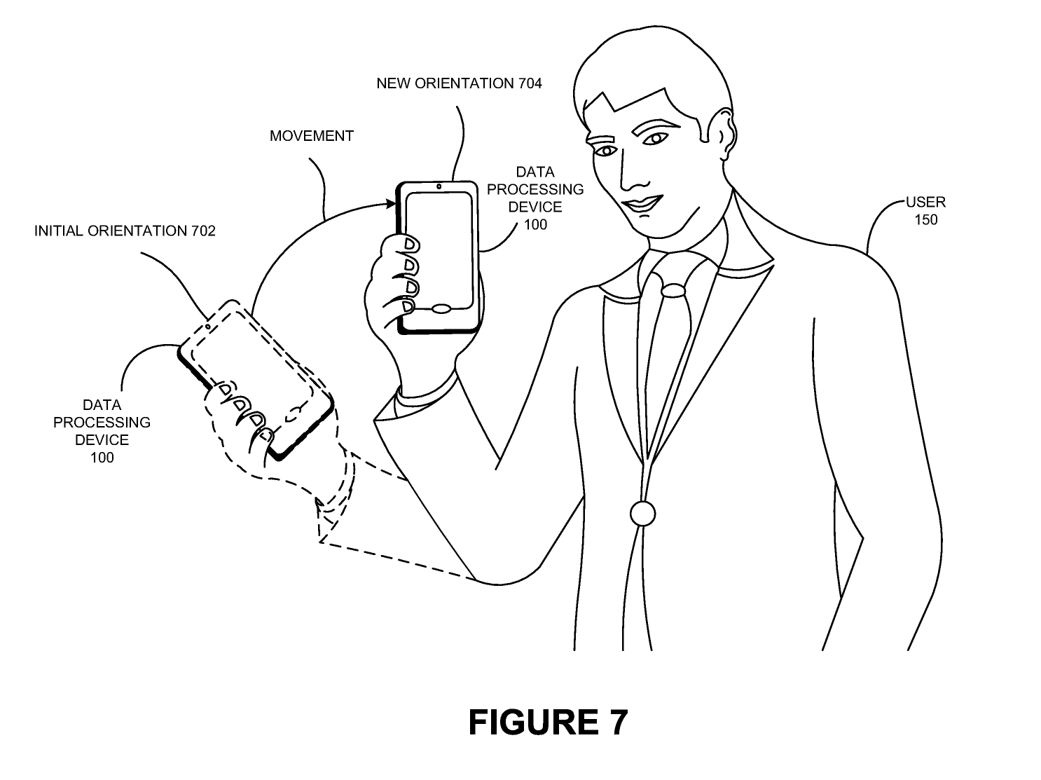

FIG. 6 shows an example coordinate system in which data processing device 100 is placed; rotational directions of data processing device 100 around x-axis 602, y-axis 604 and z-axis 606 are shown. FIG. 7 illustrates an example movement of data processing device 100 toward the ear of user 150. In the process, data processing device 100 is shifted from an initial orientation 702 thereof to a new orientation 704. Thus, the touch of user 150, in conjunction with the movement of data processing device 100 from a reference position, may be sensed along with proximity of user 150 to data processing device 100 to determine the intent of user 150 to respond to phone call 302.

It should be noted that the sensing of the touch of user 150 and the movement of data processing device 100 may not be required in one or more scenarios. For example, user 150 may be driving a car and data processing device 100 (e.g., a mobile phone) may be located in the vicinity of user 150 within the car approximately facing him/her. User 150 may move his/her ear toward data processing device 100 and the one or more sensor(s) 136 may utilize a proximity sensor to detect the intent of user 150 to respond to phone call 302 based on proximity of the ear of user 150 to data processing device 100. Therefore, contact of user 150 with data processing device 100, movement of data processing device 100 and/or proximity of data processing device 100 to the ear of user 150 may be sensed based on the appropriate scenario.

In the case of the one or more sensor(s) 136 including a proximity sensor, the proximity sensor may include an antenna configured to emit electromagnetic (e.g., infrared) radiation that is reflected, for example, from an ear of user 150 to determine proximity of the ear of user 150 to data processing device 100. Below a threshold distance, processor 102 may determine that user 150 intends to respond to phone call 302.

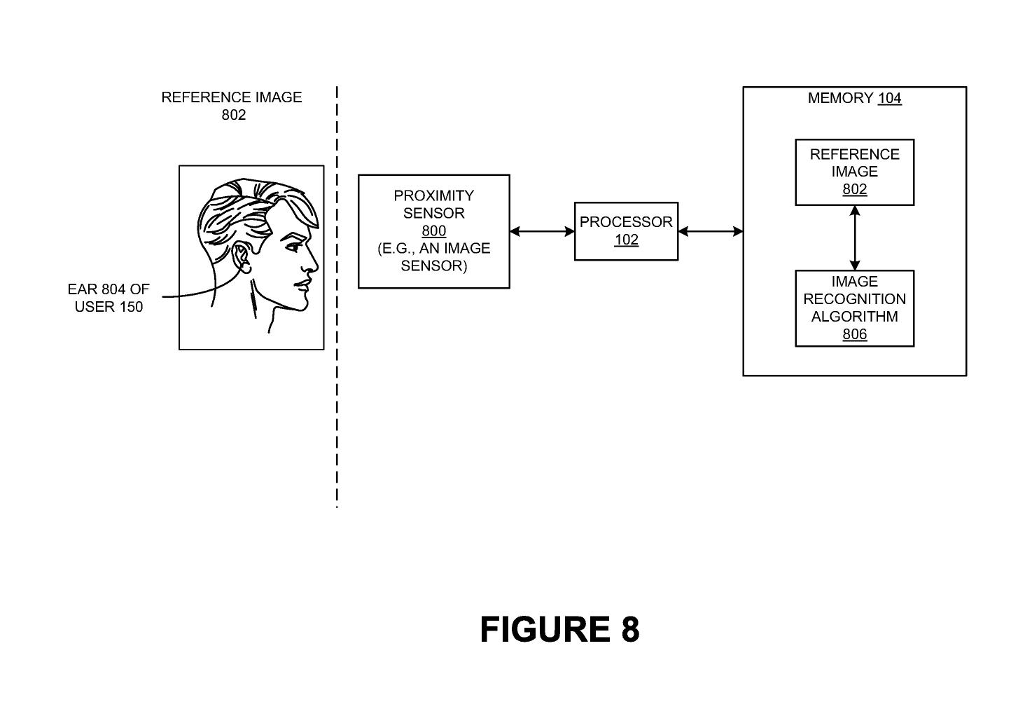

FIG. 8 shows another example proximity sensor 800. Here, proximity sensor 800 may be an image sensor (e.g., an image/video camera) of data processing device 100. Memory 104 of data processing device 100 may have reference image(s) 802 of user 150 including an ear 804 thereof stored therein; the various reference image(s) 802 may correspond to various distances between user 150 or ear 804 thereof and data processing device 100. Memory 104 may also include one or more image recognition algorithm(s) (e.g., image recognition algorithm 806) to be executed on processor 102. The pixel characteristics of reference image(s) 802 may vary in accordance with a distance between user 150 (or, ear 804 of user 150) and data processing device 100. Now, when user 150 brings data processing device 100 close to ear 804 thereof or ear 804 thereof close to data processing device 100, proximity sensor 800 may sense the intent of user 150 to respond to phone call 302 in conjunction with processor 102 based on executing image recognition algorithm 806 to detect the proximity of ear 804 to data processing device 100.

The event required to trigger the sensing of the intent of user 150 to respond to phone call 302 may not solely be restricted to phone call 302. For example, for a desired period of time, user 150 may opt to enjoy the benefits of connecting to phone calls 302 without intervening therefor on data processing device 100. Here, the sensing may be initiated through a predefined movement of data processing device 100, through a physical button on data processing device 100, through a virtual interface (e.g., a button) accessible through a screen of display unit 106, through a voice command interpretable through processor 102 of data processing device 100, through a coded gesture (e.g., a tapping pattern of a finger/fingers of user 150) interpretable through appropriate circuitry provided in data processing device 100 in conjunction with processor 102, through appropriate one or more hotkey(s) and/or through a text input interpretable through processor 102. Other forms of initiation are within the scope of the exemplary embodiments discussed herein. Broadly, the sensing may either be call-initiated or user-initiated.

With regard to proximity sensing, it should be noted that the sensing of the proximity of ear 804 of user 150 may not be required in certain scenarios. For example, user 150 may keep data processing device 100 in a pocket of a piece of clothing (e.g., trousers) thereof. User 150 may have pre-initiated the sensing through the one or more sensor(s) 136; the one or more sensor(s) may include an image sensor configured to periodically (or continuously) capture an image of a background environment of data processing device 100 when within the pocket. Here, the reference image may have dark constituent pixels because of data processing device 100 being in the pocket. Upon receipt of phone call 302, user 150 may pick data processing device 100 from the pocket to respond thereto. The image sensor may capture a new image of the background environment of data processing device 100 and, in conjunction with processor 102, determine that the new image captured includes bright pixels. Thus, the intent of user 150 to respond to phone call 302 may be sensed. It should be noted that touch sensing and motion sensing may not be required here.

Further, it should be noted that exemplary embodiments are not restricted to automatic connection to phone call 302. Concepts associated with the exemplary embodiments are also applicable to automatic disconnection of phone call 302 through data processing device 100. The data flow related to the automatic disconnection of phone call 302 is analogous to that of the automatic connection to phone call 302 through data processing device 100. Again, the sensing may either be call-initiated or user-initiated.

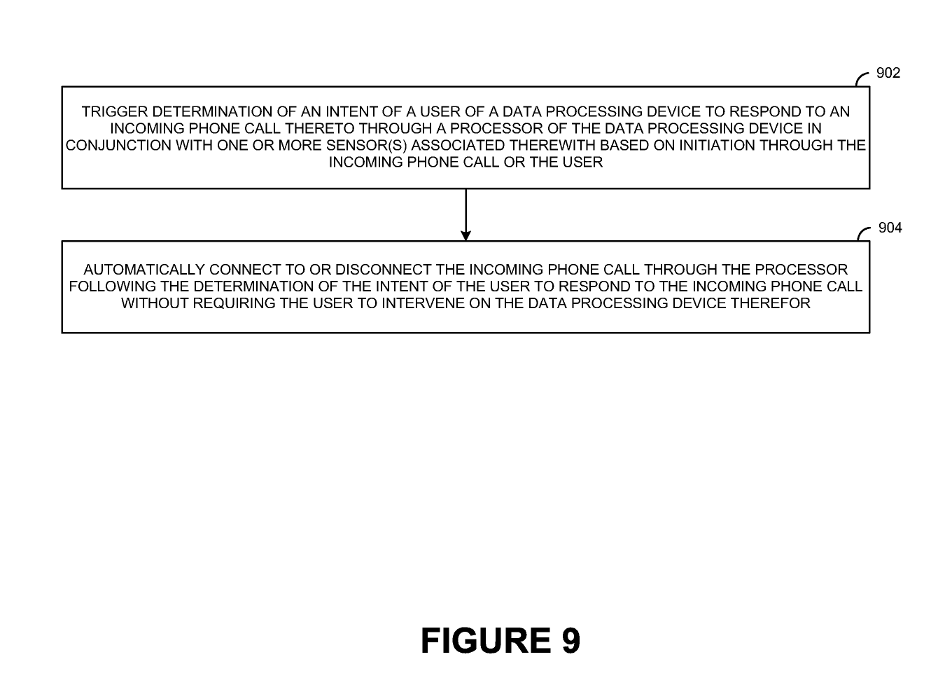

FIG. 9 shows a process flow diagram detailing the operations involved in automatic connection/disconnection of phone call 302 to data processing device 100 based on determining intent of user 150 to respond to phone call 302, according to one or more embodiments. In one or more embodiments, operation 902 may involve triggering determination of the intent of user 150 to respond to phone call 302 through processor 102 in conjunction with the one or more sensor(s) 136 based on initiation through phone call 302 or user 150. In one or more embodiments, operation 904 may then involve automatically connecting to or disconnecting phone call 302 through processor 102 following the determination of the intent of user 150 to respond to phone call 302 without requiring user 150 to intervene on data processing device 100 therefor.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., data processing device 100). Accordingly, the specification and drawings are to be regarded in an illustrative rather than a restrictive sense.

What is claimed is:

1. A method comprising:
triggering determination of an intent of a user of a data processing device to respond to an incoming phone call thereto through a processor of the data processing device in conjunction with at least one sensor associated therewith based on initiation through one of: the incoming phone call and the user; and
automatically one of: connecting to and disconnecting the incoming phone call through the processor following the determination of the intent of the user to respond to the incoming phone call without requiring the user to intervene on the data processing device therefor.

2. The method of claim 1, comprising providing at least one of:
a touch sensor configured to detect contact of the user with the data processing device indicative of the intent,
a motion sensor configured to detect motion of the data processing device indicative of the user being a cause thereof, and
a proximity sensor configured to detect proximity of the data processing device to the user indicative of the intent.

3. The method of claim 2, comprising providing as the proximity sensor at least one of:
an image sensor configured to capture an image of at least one of: the user, an ear of the user, and a background environment of the data processing device, and
an antenna configured to sense a change in a radiation characteristic thereof.

4. The method of claim 1, wherein the initiation of the determination of the intent of the user to respond to the incoming phone call through the user comprises initiation through at least one of:
a physical movement of the data processing device interpretable therethrough,
a voice command interpretable through the processor,
a physical button on the data processing device,
a virtual interface accessible through a screen of a display unit of the data processing device,
a text input interpretable through the processor,
a coded gesture interpretable through the processor,
at least one hotkey, and
a user interface of at least one of an application executing on the data processing device and an operating system executing on the data processing device.

5. The method of claim 1, comprising triggering, through a driver component associated with at least one of the processor, the at least one sensor and a display unit of the data processing device, the determination of the intent of the user to respond to the incoming phone call and the automatic one of: the connection and the disconnection of the incoming phone call based on the initiation through the one of: the incoming phone call and the user.

6. The method of claim 1, wherein the automatic one of: the connection and the disconnection of the incoming phone call further comprises contextually selecting, through the processor, a functionality associated with the one of: the connection and the disconnection of the incoming phone call from a memory communicatively coupled to the processor, the memory comprising correspondence between functionalities associated with the data processing device and elements of an input device thereof.

7. The method of claim 5, comprising providing the driver component at least one of: packaged with an operating system executing on the data processing device and packaged with an application executing on the data processing device.

8. A non-transitory medium, readable through a data processing device and including instructions embodied therein that are executable through the data processing device, comprising:
instructions to trigger determination of an intent of a user of a data processing device to respond to an incoming phone call thereto through a processor of the data processing device in conjunction with at least one sensor associated therewith based on initiation through one of: the incoming phone call and the user; and
instructions to automatically one of: connect to and disconnect the incoming phone call through the processor following the determination of the intent of the user to respond to the incoming phone call without requiring the user to intervene on the data processing device therefor.

9. The non-transitory medium of claim 8, comprising instructions compatible with at least one of:
a touch sensor configured to detect contact of the user with the data processing device indicative of the intent,
a motion sensor configured to detect motion of the data processing device indicative of the user being a cause thereof, and
a proximity sensor configured to detect proximity of the data processing device to the user indicative of the intent.

10. The non-transitory medium of claim 9, comprising instructions compatible with the proximity sensor being at least one of:
an image sensor configured to capture an image of at least one of: the user, an ear of the user, and a background environment of the data processing device, and
an antenna configured to sense a change in a radiation characteristic thereof.

11. The non-transitory medium of claim 8, wherein the instructions to initiate the determination of the intent of the user to respond to the incoming phone call through the user comprise instructions to initiate through at least one of:
a physical movement of the data processing device interpretable therethrough,
a voice command interpretable through the processor,
a physical button on the data processing device,
a virtual interface accessible through a screen of a display unit of the data processing device,
a text input interpretable through the processor,
a coded gesture interpretable through the processor,
at least one hotkey, and
a user interface of at least one of an application executing on the data processing device and an operating system executing on the data processing device.

12. The non-transitory medium of claim 8, comprising instructions to trigger, through a driver component associated with at least one of the processor, the at least one sensor and a display unit of the data processing device, the determination of the intent of the user to respond to the incoming phone call and the automatic one of:
the connection and the disconnection of the incoming phone call based on the initiation through the one of: the incoming phone call and the user.

13. The non-transitory medium of claim 8, wherein the instructions to automatically one of: connect to and disconnect the incoming phone call further comprise instructions to contextually select, through the processor, a functionality associated with the one of: the connection and the disconnection of the incoming phone call from a memory communicatively coupled to the processor, the memory comprising correspondence between functionalities associated with the data processing device and elements of an input device thereof.

14. A data processing device comprising:
a memory;
at least one sensor; and
a processor communicatively coupled to the memory and the at least one sensor,
wherein one of: an incoming phone call to the data processing device and a user of the data processing device is configured to trigger determination of an intent of the user to respond to the incoming phone call through the processor in conjunction with the at least one sensor, based on which the processor is configured to execute instructions to: automatically one of: connect to and disconnect the incoming phone call without requiring the user to intervene on the data processing device therefor.

15. The data processing device of claim 14, wherein the at least one sensor comprises at least one of:
a touch sensor configured to detect contact of the user with the data processing device indicative of the intent,
a motion sensor configured to detect motion of the data processing device indicative of the user being a cause thereof, and
a proximity sensor configured to detect proximity of the data processing device to the user indicative of the intent.

16. The data processing device of claim 15, wherein the proximity sensor comprises at least one of:
an image sensor configured to capture an image of at least one of: the user, an ear of the user, and a background environment of the data processing device, and
an antenna configured to sense a change in a radiation characteristic thereof.

17. The data processing device of claim 14, wherein the user is configured to initiate the determination of the intent of the user to respond to the incoming phone call through at least one of:
a physical movement of the data processing device interpretable therethrough,
a voice command interpretable through the processor,
a physical button on the data processing device,
a virtual interface accessible through a screen of a display unit of the data processing device,
a text input interpretable through the processor,
a coded gesture interpretable through the processor,
at least one hotkey, and
a user interface of at least one of an application executing on the data processing device and an operating system executing on the data processing device.

18. The data processing device of claim 14, further comprising a driver component associated with at least one of the processor, the at least one sensor and a display unit of the data processing device to trigger the determination of the intent of the user to respond to the incoming phone call and the automatic one of: the connection and the disconnection of the incoming phone call based on the initiation through the one of: the incoming phone call and the user.

19. The data processing device of claim 14, wherein the processor is configured to execute instructions to automatically one of: connect to and disconnect the incoming phone call based on contextually selecting a functionality associated with the one of: the connection and the disconnection of the incoming phone call from the memory, the memory comprising correspondence between functionalities associated with the data processing device and elements of an input device thereof.

20. The data processing device of claim 18, wherein the driver component is at least one of: packaged with an operating system executing on the data processing device and packaged with an application executing on the data processing device.
